(19) United States
(12) Patent Application Publication
(10) Pub. No.: US 2013/0149683 A1
(43) Pub. Date: Jun. 13, 2013

(54) SYSTEM AND METHOD FOR SYMPTOM BASED REPORTING

(71) Applicant: Christine Steerman, Rochester, NY (US)

(72) Inventor: Christine Steerman, Rochester, NY (US)

(21) Appl. No.: 13/711,920

(22) Filed: Dec. 12, 2012

Related U.S. Application Data
(60) Provisional application No. 61/570,280, filed on Dec. 13, 2011.

(51) Int. Cl. G09B 19/00

(52) U.S. Cl. CPC G09B 19/00
USPC 434/236

(57) ABSTRACT

The present invention provides a computer-assisted process for receiving cognitive behavior data for use in a therapy, the computer-assisted process comprises the steps of: (a) providing at least one mobile device to a patient, wherein the at least one mobile device is functionally connected to a central repository; (b) capturing and storing, in the central repository, via an interface on the at least one mobile device, the cognitive behavior data of the patient, thereby enabling remote and impromptu receipt of the data without delay; (c) retrieving the cognitive behavior data of the patient from the central repository; (d) reviewing the cognitive behavior data by the health care provider as part of the therapy to produce a review; and (e) having the health care provider prescribe treatment based on the review.

This non-provisional application claims priority to provisional application U.S. Ser. No. 61/570,280 filed Dec. 13, 2011. Said application is incorporated by reference herein in its entirety.

### BACKGROUND OF THE INVENTION

1. The Field of the Invention

The present invention is directed generally to a system and method for symptom based reporting in the psychotherapeutic treatment according to cognitive behavior theory. More specifically, the present invention is directed to a mobile system and method to improve the effectiveness of cognitive behavior therapy.

2. Background Art

U.S. Pat. No. 5,718,247 to Frankel discloses a process and apparatus for interactive psychotherapy in which information produced during a patient's therapy is categorized according to data type. The information is then stored to a series of interconnected databases stored in a computer. Empirical data and historical data are developed first, and stored. Then generalizations (patterns) are derived from this data, and stored. After generalizations have been stored, hypotheses (explanations of generalizations) are developed and stored. The hypotheses are evaluated and tested to determine their truth or falsity. Simultaneously with the derivation of hypotheses, goals are derived from the generalizations, and stored. These goals are periodically evaluated to assess the patient's progress. Finally, possible actions to accomplish the goals are derived, each action being based on a hypothesis. The patient and therapist are provided with simultaneous access to the computer for entry and retrieval of information. The computer has a means of data entry and a means of display for both therapist and patient. Storage is provided for the databases. These databases are accessed jointly by the patient and therapist during the therapy sessions, as well as by the therapist before, during, or after therapy sessions. The information is then stored to a series of interconnected databases stored in a computer. Although the use or access of computers is critical in Frankel, it does not provide a means for enabling entry of data from patients remotely in an impromptu manner and outside of in-office therapy sessions.

It is known to use a computer to store patient information arising from psychotherapy. In U.S. Pat. No. 5,435,324 to Brill, a computer is used to measure a patient's psychotherapy process. A questionnaire measuring psychological variables is administered to the patient to obtain initial information. Responses to the questionnaire are used to compute single-valued quantities as psychological measures of the patient. Computed scores from subsequent therapy sessions are then compared to quantify the patient's progress. The apparatus and method of Brill are configured specifically for use by the therapist only. No provision is made for the patient to use the computer at any time. The patient is thus not participating at a very active level in his/her therapy. The therapist-patient power dynamic developed during some prior art therapy can often impair the therapeutic process. It would therefore be advantageous to provide a system and method that increases participation of a patient in his/her therapy and a means by which the patient is allowed to report cognitive based data promptly as symptoms arise.

Various challenges are encountered in a conventional therapy practice. One major problem associated with a conventional therapy practice is due to the fact that the time afforded to a patient is limited. Further, the number of therapy sessions covered by insurance companies has been decreasing due to rising healthcare costs. Rising healthcare costs have also prompted insurance companies to provide less healthcare coverage, forcing patients to pay more to maintain the same level of services. Scheduling challenges and incomplete data provided to the therapist may further hamper efforts to provide quality care to patients. Problems associated with patients typically arise outside of therapists' offices. Therefore, it is impractical to bring materials learned in a therapy session into actual live context, further presenting the disconnectedness of therapies and patients. In addition, patients often fail to practice skills learned during therapy outside of therapy settings.

As therapists spend a large proportion of time maintaining records, there is relatively little time spent on drawing meaningful data from these records. In addition, there is pressure in the field for treatment to be evidence based or evidence driven. Therapists can follow a “research based” program but experienced therapists often find that the strictly defined treatment groups used in research do not correspond to real world patients who typically have multiple problems. Experienced clinicians use their own judgment and the input of the client to decide on a treatment plan which often is a combination or portion of published paradigms. For instance, a typical cognitive processing program recommends a 12 week program with weekly sessions. There are written assignments or homework to be done in between two successive sessions. It is unusual for the full program to be carried out as specified in the homework, making data analysis difficult. For clinicians, the most efficient way to assess and show evidence of progress is by client report as clients may or may not have kept records. It is infrequent for a client to bring in a record that demonstrates how they have been doing even if it is expressly part of the treatment plan.

At times of crisis, a patient often comes in feeling as if they have made no progress, that their symptoms are worse than before. Having the data to show them quantitatively what they have accomplished helps them keep current events and challenges in perspective, and more accurately assesses how they are doing.

As is well known in addiction work, the very act of keeping data, affects a patient's behavior. It has long been known that in smoking cessation and weight loss programs, if a client tracks his/her consumption, the consumption reduces. Similarly, it has been Applicant's experience that the very act of tracking a panic attack at the time of the panic attack can reduce the panic attack. Thus, active real time reporting provides a therapeutic treatment benefit to the patient.

Another critical element to cognitive behavioral therapy is the identification of antecedent events, or triggers. This program allows the consumer to identify triggers and accompanying maladaptive thoughts and behaviors at the time a symptom manifests and to do so whenever the symptom occurs. This critical information is often forgotten by the time a patient comes to an appointment days or weeks later. The practice of identifying these triggers and considering appropriate strategies (provided on the mobile device) help establish the desired and adaptive habit. The important principles of behavior management, that of “shaping” and “successive approximation” are embodied herein. The patient's behavior gradually changes in the desired direction within the context in which the symptom occurs. With each event occurrence, the patient gradually moves in the direction of becoming able to generate adaptive coping strategies without relying on the cues on the mobile device. The ultimate goal of therapy is the ability of the client to function independently. However, if needed the patient can always refer to the device.

As behavioral research indicates, it is common for a behavior to temporarily increase when reinforcement is withdrawn before decreasing. It is also common for a behavior to recur at times after being successfully reduced or eliminated. While these attributes are typically explained to patients in a session, when they actually experience them in real life, the tendency is to lose this perspective and decide that the program is not working. As a result, they return to their old ways which were not working, detracting from the effectiveness of the therapeutic treatment regimen. Applicant discovered that keeping cognitive behavior data helps patients see the patterns for themselves. It also helps the therapist assess if a program actually needs adjustment. Thus, real time symptom reporting by a patient can positively affect the treatment progress and success for a patient.

Given the foregoing, what are needed are systems and methods for promptly communicating and record keeping of symptoms of patients as they arise. There lacks a tool which uniquely brings together three critical predictors of treatment success: (1) the therapeutic benefits provided by the therapist to the patient or provided by a device assigned by the therapist to the patient; (2) the identification of internal or external triggers; and (3) the patients' practice of new skills learned in therapy outside the therapeutic environment.

### SUMMARY OF THE INVENTION

The present invention meets the above-identified needs by providing a system and method for collecting patient's symptom based data.

In one aspect, the present invention provides a computer-assisted process for receiving cognitive behavior data for use in a therapy and comprises the steps of:
(a) providing at least one mobile device to a patient, wherein the at least one mobile device is functionally connected to a central repository;
(b) capturing and storing, in the central repository, via an interface on the at least one mobile device, the cognitive behavior data of the patient, thereby enabling remote and impromptu receipt of the data without delay;
(c) retrieving the cognitive behavior data of the patient from the central repository;
(d) reviewing the cognitive behavior data by a therapist as part of the therapy to produce a review; and
(e) having the therapist prescribe treatment based on the review.

The step of capturing and storing is configured to encourage participation of the patient in the therapy and to discourage negative behaviors the therapy is designed to control. The Applicant discovered that by requiring patient interactions with the mobile device, the patient is held accountable to the mobile device, which in essence, serves as a confidant.

The computer-assisted process further comprises:
(a) retrieving historical cognitive behavior data; and
(b) graphing the cognitive behavior data and the historical cognitive behavior data such that cognitive behavior change is discernible over time.

In one embodiment, the step of capturing and storing is performed at predetermined time intervals. In another embodiment, the step of capturing and storing is performed at an ad hoc basis according to the need of the patient. In one embodiment, the computer-assisted process further comprises a step of alerting the patient preceding the step of capturing and storing. The computer-assisted process further comprises a step of adding the cognitive behavior data and historical cognitive behavior data to a treatment record associated with the patient to produce evidence based care.

Through the use of a combination of web-based computer and mobile technology, the present system and method provides the therapist and patients a way to track symptoms, responses to treatment, and the success (or the lack of) of the strategies chosen during their treatment sessions. The mobile device functions as a reminder, a guide, a data keeping tool, and a communication tool between the patients and their therapist. Information transmitted with the device can be reviewed by the therapist and discussed in treatment sessions. Patient information is stored securely on a web server and can be downloaded to become a part of patients' treatment records.

Typically a clinician has a mobile application or web application on his or her computer and the patient has the data forms they need available to them on their mobile device. The content and options offered on the forms may be based on cognitive and behavioral literature. As research is not conducted on the general population, the forms are designed to be customizable. The data from the patients' device is securely transmitted to a web server and then downloaded by the therapist to his/her computer for use in sessions and to help guide the patient's treatment.

In one embodiment, a patient's satisfaction of an in-office visit is incorporated in the determination of the next treatment plan. The computer-assisted process further comprises:
(a) receiving survey results from the patient responding to a survey regarding the in-office visit; and
(b) having the therapist prescribe treatment based on the survey results;

Accordingly, it is a primary object of the present invention to provide a system and method which enables impromptu reporting of symptoms by therapy patients such that the accuracy of such reporting is not compromised.

It is another object of the present invention to provide a system and method which enables submission of raw data collected in an impromptu manner and/or the charted data derived from the raw data to a healthcare consumer's treatment record, thereby providing improved “evidence-based” care.

It is another object of the present invention to provide a system and method which enables impromptu collection of patient symptoms and automatic derivation of patient progress for use during a patient's meeting with his/her therapist and whenever a review of such data is desired.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram of an exemplary system for capturing and storing patient's data depicting the functional connection of a mobile device used by a patient, web servers and a central system.

FIG. 2 is a block diagram depicting an exemplary computer system useful for implementing a symptom based reporting system and method of the present invention.

FIG. 3 is a block diagram depicting the present and other uses of the present invention.

FIG. 4 is a table depicting benefits of the present symptom based reporting system as compared to self-help and pure in-office therapy sessions.

FIG. 5 is a flow chart depicting an exemplary process useful in implementing the present symptom based reporting system.

FIG. 6 depicts an example set of questions designed for soliciting cognitive behavior data.

FIG. 7 is a block diagram depicting encrypted communication between a mobile device and a central system.

FIG. 8 are images of exemplary interfaces served on a mobile device to a patient useful for soliciting and receiving data from the patient.

FIG. 9 are images of exemplary reports accessible to both a patient and a therapist.

FIG. 10 is block diagram of another embodiment of the present symptom based reporting system and method, depicting the matching of more than one therapist with one or more patients.

### PARTS LIST

2—central system
4—central repository
6—web servers
8—internet
10—firewall
12—computer used by therapist
14—communication between cellular network and mobile device
16—communication between internet and mobile device
18—mobile device
20—cellular network
22—patient
24—therapist or health care provider (HCP)
26—cognitive behavior therapy
30—medication and pain logs
32—medical provider
34—behavioral progress
36—behavior and family therapist
38—table contrasting benefits of symptom based reporting, self help and conventional therapy
40—step of a healthcare provider becoming a member of the system provider by purchasing a monthly membership online
42—step of a healthcare provider downloading an application to their computer and for viewing available forms
44—step of healthcare provider determining the forms available on the program that are appropriate for a particular healthcare consumer depending on the consumer's treatment program
46—step of giving written information about the application and how it works in an appointment where the healthcare provider meets a healthcare consumer
48—step of a healthcare consumer signing an agreement giving the healthcare provider permission to use the application in their care and stating an understanding of any liability or risks
50—step of a healthcare consumer providing his/her healthcare provider with a current contact (e.g. email address)
52—step of creating a user account for a healthcare consumer by entering the healthcare consumer's name and email address and inviting the healthcare consumer to access the healthcare user account.
54—step of healthcare provider giving the user name to the healthcare consumer
56—step of healthcare provider assigning appropriate forms to the consumer
58—step of providing a unique secure password by email to the healthcare consumer, along with information regarding the means by which to add an application icon to the consumer's mobile device homescreen
60—step of consumer opening the application and using it at predetermined time intervals
62—step of consumer entering data and submitting data by means of secure encryption to the online server at appropriate times
64—step of healthcare provider downloading encrypted data (entered by the consumer) to a computer
66—step of reviewing data with the healthcare consumer during appointments to further inform treatment
70—step of adding data from the program to the healthcare consumer's treatment record, providing improved “evidence-based” care
72—step of using information collected from consumer to collaborate with other providers depending on the release of information agreements with the consumer
72—exemplary user interface
74—exemplary reports

### PARTICULAR ADVANTAGES OF THE INVENTION

There exist mobile applications developed to help populations with various problem areas. While useful, there remain shortcomings that are not addressed until now using the present system and method. Prior art mobile applications are essentially “boiler plate” or generic non-professional tools. They lack the collaboration or integration into a patient's treatment plan. They are designed for generic sets of problems and not with individual differences in mind. As the solutions are geared to be all-inclusive, they become inefficient. The alternative is to become simplistic. Cognitive behavioral therapy and other therapies can be powerful tools. The act of diluting complex cognitive behavioral therapy for “public consumption” causes the therapies to lose much of their power. In addition, consumers often search for and choose these products on their own. They often do not have a way of assessing the appropriateness of the product. It is left up to the individual to decide how to use a product. The consumers lack someone to help them understand the basic rationale and purpose of the programs, and the parts that are applicable to them. There also lacks coordination of care.

In a self-directed or self-help therapy including independent phone applications, various benefits may be realized, albeit incomprehensively. A self-directed therapy is relatively inexpensive and can be used according to a patient's schedule. In addition, patients can search and find some resources on their own. For patients having suitable mobile phone platforms, independent phone applications may be used to run those platforms to perform self directed therapy. There are, however, challenges associated with a self-directed therapy. Patients may not know the rationale, reason and the method by which various strategies are helpful. Patients may have inadequate support as they may not have trained professionals accessible outside the therapist's office to help them when they do not know how to proceed with a program or when they fail to remember what they are to do. Further, patients may not know which techniques described in the self help resource are appropriate and useful for them. Without feedback, patients often do not finish these programs or are not sure how to apply them to their own lives. Yet further, there lacks guidance or feedback regarding the patient's progress. Self-directed therapies are not individualized, as a generic “one size fits all” solution is provided, therefore lacking specificity required for each patient. In addition, some resources may be better than others forcing the patients to assess validity and appropriateness on their own. In some cases, therapists may suggest various resources for patients to use as adjunct to therapy. However the present system and method is the only means by which to integrate patients' work outside the therapist's office with work inside the therapist's office.

The present system and method is web-based, therefore is not limited to a specific mobile phone platform. It can be accessed on any computing devices, such as smart phones, any mobile devices and computers capable of functional connection with the internet. The application accessed by patients or therapists is conveniently served by a web server and the data provided by patients is stored securely in at least one central repository. The therapist and even the patient have access to the data as soon as the data has been submitted by the patient and not limited to when the patient is in the therapist's office. The therapist is capable of viewing the data and summary graphs on a full size computer screen. During appointments, the present system allows patients and their providers to view information together without having to view a small phone screen together.

The problems that prompted the development of the present system and method are disclosed herein along with the ways in which the present system and method addresses them. Clients come into therapy because of problems they are having in the real world, not in a doctor's office. A predictor of change lies in the act of practicing skills learned in therapy in the situations in which the problems occur. It is impractical for a therapist to accompany patients for a long period of time in order to observe their symptoms while they live their daily lives. With the exception during emergencies, patients do not have access to additional support by their therapists when they are in these situations. A mobile device is provided in the present system to solve this problem. The mobile device includes the display of recommended strategies along with measurements taken before and after a symptom has occurred. Mobile devices are accessible in all contexts that are targeted, i.e., home, in the car, at work, bedtime, mealtime, in the bathroom and the like.

The treatment of a patient is often hampered by financial and time commitments. Conventional therapies are typically scheduled around therapist and patient availability. Insurance companies are increasingly limiting services and coverage, while costs increase. This results in patients meeting less frequently with their therapists, or only at times of crisis. This means a significant part of each session is spent in review and updating, with less and less time available for teaching new skills and treatment planning. Symptom based reporting, as disclosed herein, increases efficiency of treatment and can save time and money. Symptom based reporting allows data to be recorded and submitted to increase information accuracy and completeness before the session even starts. This decreases time spent in review. The data is easily read and simply charted. Patient progress is more easily determined such that focus can be placed on helping patients in making progress instead of collecting and merging data collected during conventional therapy sessions. The need for continued treatment can be justified to insurance companies more easily as tracking of patient progress is performed more frequently and more quantitatively compared to conventional therapy.

When patients keep data by traditional methods such as by using paper and pen, they often only do it the first few days after a therapy session, or try to fill it all in from memory just before the next session. Chronology, as well as detail, is often lost. The present system provides reminders and information at hand to remind patients of their treatment plan and can help to keep them focused. An alarm can be set for reminders. Chronological order of patient data is therefore maintained.

A therapist finds it harder to recall details of the therapy, the activities performed in each session, and how the patient fared. This extends the time needed for complete record keeping and record review prior to each session. The present symptom based reporting scheme provides the therapist with accurate chronological information and graphs charts based on a patient's raw input. The patient provided data can be downloaded and added to a patient's chart. It also can be shared with other providers, where appropriate and with the patient's permission.

A patient's recall is highly affected by recency. In other words, how the patient felt the last day or two has tremendous bearing on the answers the patient provides in a therapy. The patient's recall is also affected by how they feel on the day of the appointment, and by how the reported event was resolved. In symptom based reporting, the data is transmitted in real time and therefore is not affected by recency, current emotional state or subsequent events following the occurrence of the symptom.

A large part of cognitive behavior therapy involves breaking down incidents into triggers (antecedent events). Triggers include a patient's thoughts, emotions and overall state at the time. By the time a patient comes into a session, a lot of this information is distorted or lost. A common experience with patients involves situations where the patients “don't know” or “don't remember” details of a past symptom. The mobile device of the present invention reminds the patient to attend to and record this data at the time of the event.

Patients often report that they have forgotten something that they had planned to discuss. The availability of a constant “line of communication” between a provider and a patient can cue the patient to record issues of concern as they happen.

It is inconvenient and sometimes impractical (even embarrassing) to fill out forms. The use of mobile devices for texting have become ubiquitous and mobile devices have been common sight and unremarkable. Even if something is to be recorded while driving, it is possible for the patient to take a few minutes by pulling over or entering data once they arrive to their destination.

The primary purpose of therapy is to cause behavior change. It is well known that constant practice and the creation of new habits is an essential ingredient to sustained change. It is difficult to reinforce the formation of habits with widely spaced appointments with a therapist. The present mobile device provides an extension of the therapy, a guided cue for the patient to pay attention to their internal and external triggers and practice appropriate coping strategies. By having the mobile device available to him or her at all times, it is possible for the patient to move in the direction of creating a habit.

Patients often operate under the impression that coming to therapy “is” the therapy. A successful therapy requires a patient to “work his/her plan” in between therapy sessions. For example, a person recovering from surgery progresses much faster if they do their physical therapy exercises in between physical therapy appointments. Symptom based reporting helps patients see that the most important part of the therapy occurs in between sessions when the bulk of the work is done by them.

It is well known that it takes time and consistent effort to change habits. It is felt that having a constant reminder of habits being worked on will facilitate this change process. Behavior change is gradual, in small increments, with steps forward and back. In therapy, a step backward is often interpreted by the patient as a total loss of gained ground. At this point, the patient often gives up trying. The acts of working in small increments and having the patient keep data for successful and unsuccessful incidents of symptom management help the patients understand that progress is gradual and not necessarily moving consistently in the positive direction. Graphs are provided to show uneven growth and help patients realize that there is hope in therapy. In therapy, clients have to “take the therapist's word for it” that they are making progress and that a recent lapse does not necessarily mean that the treatment is ineffective. In the event that the treatment is in fact ineffective, this also is more easily apparent with the data collected using the present system and method.

Data entry is done in a more subtle way and directly by a patient. This eliminates mistakes made in transferring raw data from non-electronic format to electronic format for review or charting purposes, thereby increasing the accuracy in reporting progress.

In cases where the patient (such as one with Attention Deficit Hyperactivity Disorder (ADHD)) is incapable of using the present mobile device, e.g., where the patient is a minor, a guardian, parent or teacher can be assigned or authorized to carry out symptom reporting on the minor's behalf.

FIG. 4 is a table summarizing benefits of the present symptom based reporting system as compared to self-help and pure in-office therapy sessions.

### DEFINITION OF TERMS

As used herein, the terms “healthcare consumer” and “patient” are used interchangeably to indicate a person receiving care from a therapist. As used herein, the term “mobile device” is defined as a computing device capable of being transported easily from a location to another location without undue difficulty and one which is capable of functional connection with a web server regardless of its location. Therefore the use of a mobile device is not discouraged by its location. A mobile device, according to the present disclosure shall comprise but not limited to smart phones, pads, tablets, personal digital assistants, mobile computers, etc. The terms “program,” “application,” “app” and “web applications” are used interchangeably to indicate a software program which runs locally on a computing device or runs remotely via the functional connection to a web server and one which receives inputs from and provides outputs to a patient or therapist. The term “secure” means patient data is protected against free access by unauthorized entities thereby ensuring the Health Insurance Portability and Accountability Act (HIPAA) privacy rule compliance.

### DETAILED DESCRIPTION OF A PREFERRED EMBODIMENT

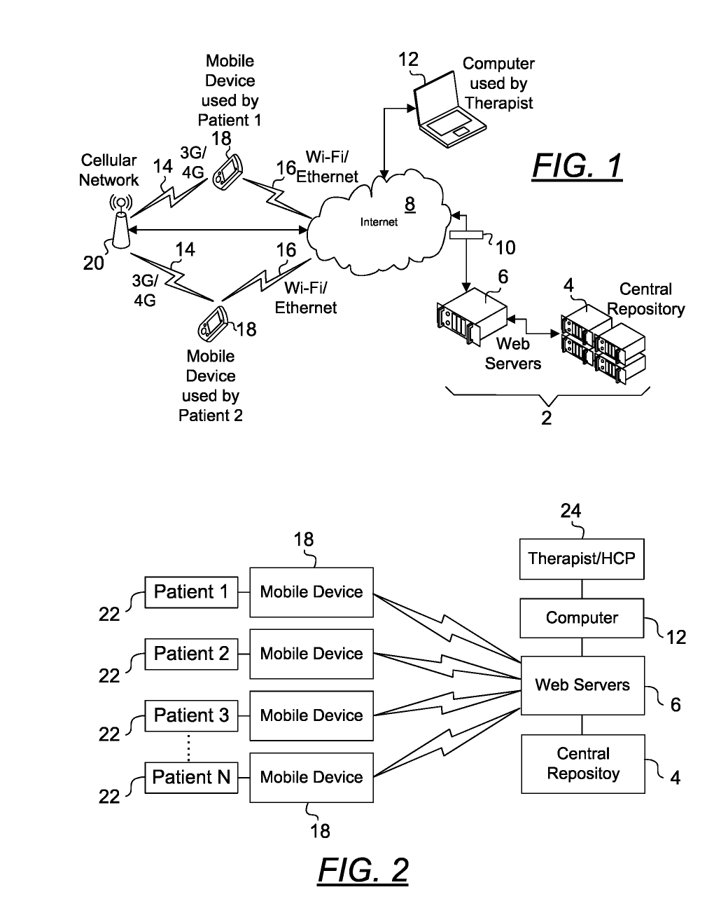

FIG. 1 is a diagram of an exemplary system for capturing and storing patient's data, depicting the functional connection of a mobile device 18 used by a patient, web servers 6 and a central system 2. As will be appreciated by those skilled in the relevant art(s), in an aspect, the traffic between the mobile devices 18 and a computer (e.g., web servers 6 and computer 12) is routed through one of the networks (e.g., cellular 20 and the internet 8). The cellular network can include 3^{rd} or third generation (3G) or 4^{th} fourth generation (4G) 14 or newer telecommunication standards while the internet 8 can include ethernet and wireless fidelity (Wi-Fi) 16 standards. The central repository 4 is operably connected to the web servers 6. FIG. 1 depicts only two mobile devices 18. However, in a practical scenario, each patient is assigned or otherwise possesses a mobile device 18 on which data can be reported to and retained in the central repository 4 by means of a web application supported by a program available in one of the web servers 6. It is also contemplated that a patient may use several mobile devices to access the web application. For example, a patient user may use a tablet in one user session and a smart phone in another user session.

FIG. 2 is a block diagram depicting an exemplary computer system useful for implementing a symptom based reporting system and method of the present invention. Multiple mobile devices 18 are operably connected to web servers 6, which are in turn operably connected to a central repository 4. Typically, during a therapy session or at any other times, a therapist 24 uses a web browser on a computer 12 to access patient data stored in the central repository 4. If desired, computer 12 may also include mobile devices 18 and any devices enabling a therapist 24 to interact with a patient and to learn of the patient's conditions. The direct and one-on-one pairing of patients 22 to mobile devices 18 enables the patients to report symptoms at regular intervals or on ad-hoc basis.

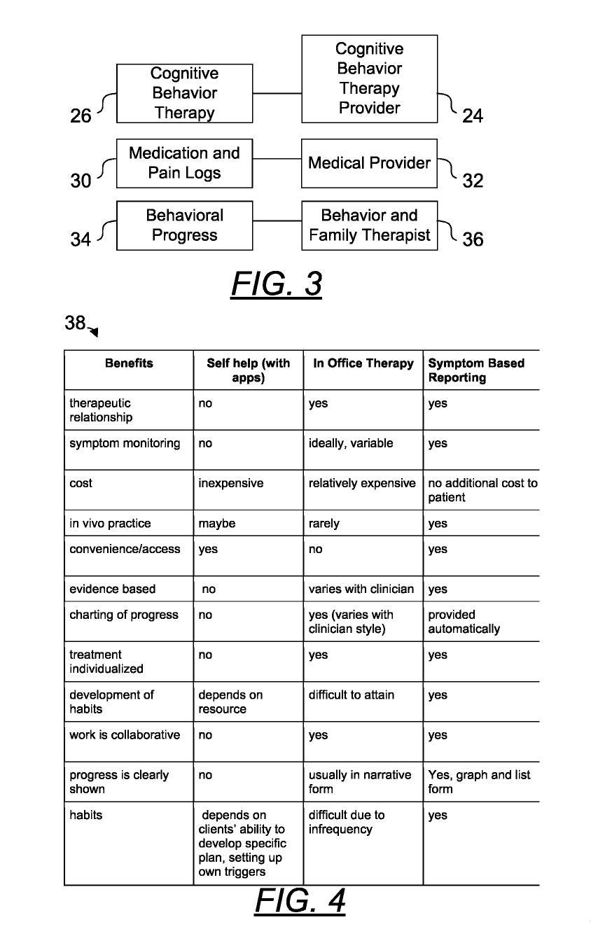

FIG. 3 is a block diagram depicting the present and other uses of the present invention. While the present system and method is geared primarily for cognitive based therapy 26, it is applicable to other areas such as child behavior 34, medication 30 or other treatment tracking. It shall become apparent, upon reading the ensuing disclosure that the present process can be used for a number of areas outside of cognitive based therapy 26. The common thread of these areas reside in the provision of a system that is capable of providing cues to users at the time of need, receiving inputs from users at any time, collecting such inputs and enabling derivation of information (such as graphing the inputs, etc.) based on such inputs. For example, the ability to submit regularly to the doctor provides a continuing connection to the doctor. When a patient becomes ill, historical data leading up to the point when the patient becomes ill can be analyzed. The historical data shall not however become a burden or requirement for doctors to propose early intervention, although various limits may be set which when exceeded, flags are raise to alert a doctor or patient.

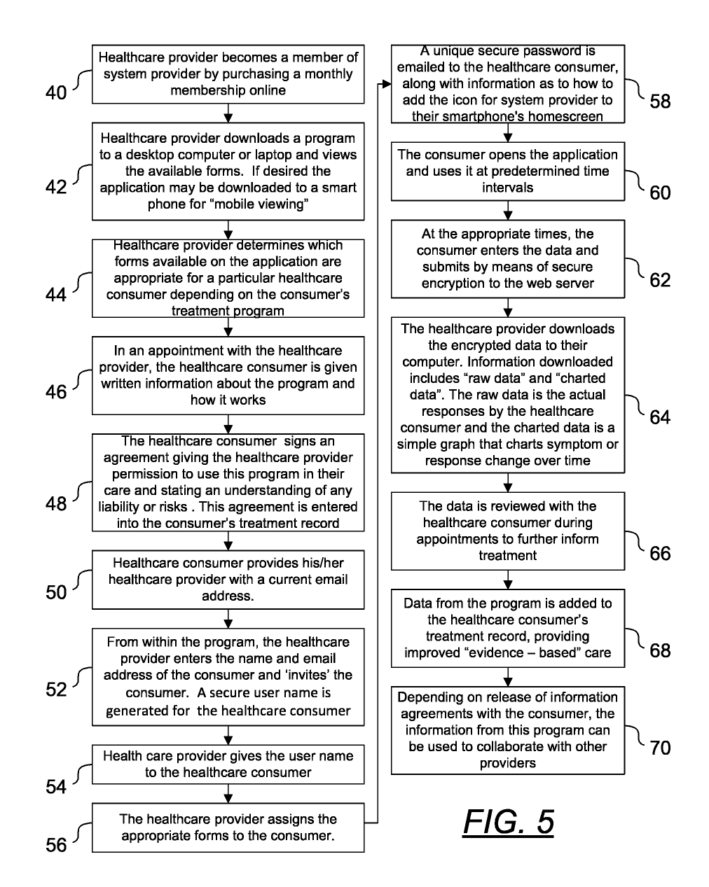

FIG. 5 is a flow chart depicting an exemplary process useful in implementing the present symptom based reporting system. In one embodiment, the present system and method is made available to the consuming public via a subscriber based system. As will also be appreciated by those skilled in the relevant art(s) after reading the description herein, in an aspect, an application service provider (i.e., an entity providing the infrastructure for one or more healthcare agencies, insurers and/or recipients) with multiple locations at one or more corresponding URLs may allow access, on a paid subscriber/membership, and/or pay-per-use basis, to the tools (i.e., web application) the present invention provides for facilitating patient symptom reporting and data processing services. Therapists are generally clients to whom such system and method is targeted although a patient, hospitals, private companies, health agencies, insurance providers and other health service providers may also engage such system and method if so desired. FIG. 5 depicts an engagement of such a system and method by a therapist. In step 40, a healthcare provider or therapist becomes a member of the application service provider by purchasing a monthly membership online. Such membership may entail staged pricing, e.g., the cost of membership is proportional to the number of patients of a member. In one example, the cost incurred on a member is a set fee for 1-20 patients. From more than 20 patients, an additional fee of a certain percentage may be incurred.

Step 42 depicts an example by which an application is made available to a healthcare provider. In one embodiment, an application made available locally on a computer is provided. In this instance, a healthcare provider downloads an application to a desktop computer, laptop or mobile device for viewing available forms. In another embodiment, the application is provided by a web application stored on a web server. As will be appreciated by those skilled in the relevant art(s), in an aspect, the web application described above executes on one or more web servers 6 (as shown in FIG. 1) providing one or more websites which send out web pages in response to Hypertext Transfer Protocol (HTTP) or Hypertext Transfer Protocol Secured (HTTPS) requests from remote browsers residing in a mobile device or a desktop computer. Thus, such web servers 6 are able to provide a graphical user interface (GUI) to users of the mobile device 18 or desktop or other devices utilizing the web application of the web servers 6 in the form of web pages. These web pages are sent to mobile device 18, desktop or like terminal devices and result in the GUI screens being displayed.

In step 44, the healthcare provider determines the forms available on the application that are appropriate for a particular healthcare consumer depending on the consumer's treatment program. Exemplary cognitive behavior treatment programs include, but are not limited to anger, anxiety, exposure, medication response, mood changes, pain level, panic, pain, urge resistance, child tantrum, child bedtime, bullying, and the like. Upon selecting a treatment program best suited for the healthcare consumer, the healthcare provider continues by giving written information about the application and how it works in an appointment where the healthcare provider meets a healthcare consumer (as shown in step 46).

In step 48, the healthcare consumer signs an agreement giving the healthcare provider permission to use the application in their care and states an understanding of any liability or risks. This agreement is entered into the consumer's treatment record. In step 50, the healthcare consumer provides his/her healthcare provider with current contact information (e.g. email address). Upon receiving this current contact information, a user account is created (as shown in step 52) for the healthcare consumer by entering the healthcare consumer's name and email address and inviting the healthcare consumer to access the healthcare user account. A secure user name is generated for the healthcare consumer. In step 54, the healthcare provider gives the user name to the healthcare consumer.

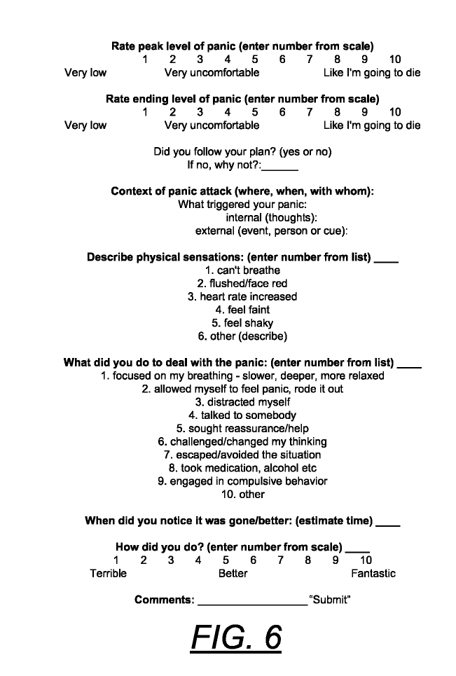

In step 56, the healthcare provider assigns appropriate forms previously determined in step 44 to the consumer. In a local install of the application, the act of assigning forms may be performed once during the download and installation process of the application and periodically updated after the installation of the application. In a web application, the act of assigning forms is performed simply by uploading a series of forms associated with a treatment program to a web server and assigning the memory location of the series of forms to which a pointer of the treatment program points to. In step 58, a unique secure password is provided by email to the healthcare consumer, along with information regarding the means by which to add an application icon to the consumer's mobile device home screen. In another embodiment, as in the case of a web application, the icon is simply a book-marked website on a web browser. In such instance, a web browser shortcut may be established on a home screen for speedy access to one's account. In one embodiment, the password may be saved in the application or web application to even quicker access. Upon logging into the application, the consumer is prompted to change the provided password to one that is provided by the consumer according to rules governing secure password standards. Applicant discovered that the ease with which the application or web application can be accessed is crucial in ensuring its use. Although such application may be accessed via any web-based computing device, providing access on a mobile device was found to be the main contributor to the success of the present system and method as the consumer is more keen to access the mobile device due to the proximity of the patient to the mobile device and the ease associated with submitting data when a symptom arises. In addition, the mobile device provides therapeutic value as it may be treated as a “buddy” from which the consumer can access a segment of the therapy. In step 60, a consumer opens the application or web application and uses it at predetermined time intervals or when a symptom arises. Example predetermined time intervals are hours, days, weeks, etc. FIG. 6 depicts an example set of questions designed for soliciting cognitive behavior data with respect to panic. The consumer is instructed to respond to this questionnaire at predetermined time intervals or when a panic attack arises. In the case of accessing the web application at predetermined time intervals, an alert may be programmed to indicate that it is time to access the web application. An alert may be an audio or a visual cue or it can simply be the entry and display of forms on the mobile device.

Referring back to FIG. 5 and step 62 of FIG. 5, the consumer enters data and submits data at appropriate times by means of secure encryption via a web server to a secure central repository. In step 64, the healthcare provider downloads encrypted data (entered by the consumer) to a computer. Information downloaded includes “raw data” and “charted data.” The raw data is the actual responses by the healthcare consumer and the charted data is a simple graph that charts symptom or response change over time. In the case of a web application, the raw and/or charted data is simply requested and displayed by the web application.

In step 66, the data is reviewed with the healthcare consumer during appointments to further inform the consumer of the appropriate treatment going forward. In step 70, the raw data and/or the charted data is added to a healthcare consumer's treatment record, providing improved “evidence-based” care. In contrast, collection of data in a conventional therapy is done haphazardly (delayed or forgotten), if at all, thereby causing data to be inaccurately provided during therapy. In step 72, data collected from consumer is used to collaborate with other providers depending on the release of information agreements with the consumer.

In summary, the present method is directed to a computer-assisted process for receiving cognitive behavior data for use in a therapy, comprising the steps of:
(a) providing at least one mobile device to a patient, wherein the at least one mobile device is functionally connected to a central repository;
(b) steps 60, 62—capturing and storing, in the central repository, via an interface on the at least one mobile device, the cognitive behavior data of the patient, thereby enabling remote and impromptu receipt of the data without delay;
(c) step 64—retrieving the cognitive behavior data of the patient from the central repository;
(d) step 66—reviewing the cognitive behavior data by the therapist as part of the therapy to produce a review; and
(e) step 68—having the therapist prescribe treatment based on the review.

The step of capturing and storing (steps 60, 62) is configured to encourage participation of the patient in the therapy and to discourage negative behaviors the therapy is designed to control.

The computer-assisted process further comprises:
(a) step 64—retrieving historical cognitive behavior data; and
(b) step 64—graphing the cognitive behavior data and the historical cognitive behavior data such that cognitive behavior change is discernible over time.

In one embodiment, the step of capturing and storing is performed at predetermined time intervals. In another embodiment, the step of capturing and storing is performed at an ad hoc basis according to the need of the patient. In one embodiment, the computer-assisted process further comprises a step of alerting the patient preceding the step of capturing and storing. The computer-assisted process further comprises a step (step 68) of adding the cognitive behavior data and historical cognitive behavior data to a treatment record associated with the patient to produce evidence based care.

FIG. 6 depicts an example set of questions designed for soliciting cognitive behavior data. FIG. 8 are images of exemplary interfaces 72 served on a mobile device to a patient useful for receiving data from the patient. At regular intervals or when requested, a set of questions will appear on a patient's mobile device. In one embodiment, questions are sequentially presented. For instance, the patient will not be asked to rate the ending level of panic if he/she has not rated the peak level of panic. In one embodiment, a provision is made such that the patient is able to skip a question and continue onto the next question. In another embodiment, all questions are presented at once. In this instance, it is patient's decision to select the order in which a question is answered. The patient is provided with the capability to scroll up or down the display of the mobile device on which the questions are presented. Upon satisfaction that most important questions have been answered, the patient can select to submit the answers all at once.

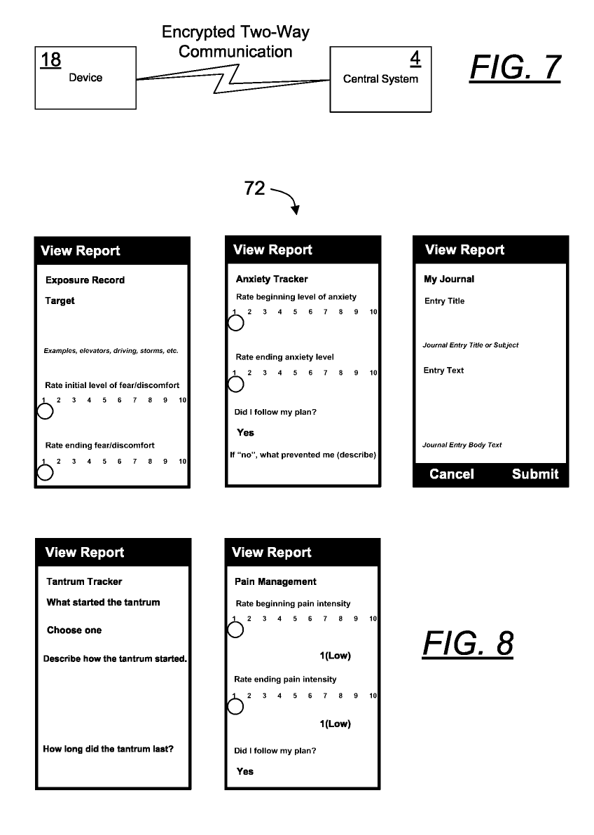

FIG. 7 is a block diagram depicting encrypted communication between a mobile device and a central system for ensuring that all data transferred between the mobile device and central system 2 is performed in a secured manner. In one aspect, the traffic described earlier is routed through one or more firewalls 10 (of FIG. 1) configured such that only authorized connections can gain access to the central system 2. The purpose of the firewall 10 is to provide security and restrict unauthorized access to the central system 2 and the patient data stored and processed therein.

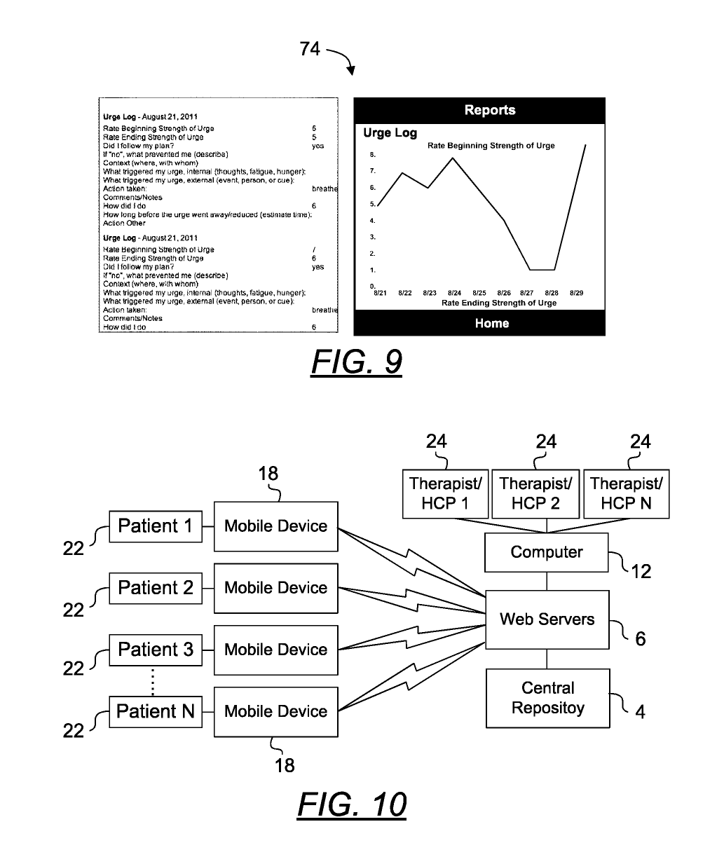

FIG. 9 are images of exemplary reports 74 accessible to both a patient and a therapist. As depicted, the reports may be presented in their raw form, i.e., strictly, in words form and/or in graph form. As depicted in step 66 of FIG. 5, the data is reviewed with the healthcare consumer during appointments to further inform the consumer of the appropriate treatment going forward. In step 70 of FIG. 5, the raw data and/or the charted data is added to a healthcare consumer's treatment record, providing improved “evidence-based” care.

In one embodiment, a survey is presented to a patient immediately upon the conclusion of an in-office visit to gather the patient's perception of the in-office visit. The patient may choose to respond to the survey via his/her prescribed mobile device or another interface. The results of such survey provide a glimpse into whether the patient felt that their therapist or other health care provider understood and responded to their concerns and whether the patient understood the prescribed treatment plan. Some patients may have difficulties expressing their concerns directly to their therapists during in-office visits and therefore do not adequately present their true conditions to their therapists. The therapist may evaluate the response and adjust the next treatment plan based on the current survey. If the patient is greatly dissatisfied, the time interval to the next in-office visit may be greatly shortened such that the patient's concerns can be more readily addressed.

FIG. 10 is block diagram of another embodiment of the present symptom based reporting system and method, depicting the matching of more than one therapist 24 with one or more patients 22. The concept and capability of matching multiple therapists of one provider or multiple providers of multiple providers to a patient is new. In cases where a patient 22 requires multiple services which are not met by a single therapist, the use of multiple health care providers 24 (either for the same or multiple segments of therapy) simultaneously is depicted in FIG. 10. In such cases, only a single copy of the cognitive behavior data and the historical cognitive behavior data is stored such that this copy reflects up-to-date data. The pairing of one patient to multiple therapists and/or providers increases the ability for providers to share important information on patient treatment and progress, resulting in improved collaboration, integration and efficiency of care.

I claim:

1. A computer-assisted process for receiving cognitive behavior data for use in a therapy, said computer-assisted process comprising the steps of:
(a) providing at least one mobile device to a patient, wherein said at least one mobile device is functionally connected to a central repository;
(b) capturing and storing, in said central repository, via an interface on said at least one mobile device, said cognitive behavior data of the patient, thereby enabling remote and impromptu receipt of said cognitive behavior data of the patient without delay;
(c) retrieving said cognitive behavior data of the patient from said central repository;
(d) reviewing said cognitive behavior data by a health care provider as part of said therapy to produce a review; and
(e) having the health care provider prescribe treatment based on said review, wherein said step of capturing and storing is configured to encourage participation of the patient in said therapy and to discourage negative behaviors said therapy is designed to control.

2. The process of claim 1, further comprising:
(a) retrieving historical cognitive behavior data; and
(b) graphing said cognitive behavior data and said historical cognitive behavior data such that cognitive behavior change is discernible over time based on said cognitive behavior data in contrast to said historical cognitive behavior data.

3. The process of claim 1, wherein said step of capturing and storing is performed at predetermined time intervals.

4. The process of claim 3, further comprising a step of alerting the patient preceding said step of capturing and storing.

5. The process of claim 1, wherein said step of capturing and storing is performed at an ad hoc basis according to the need of the patient.

6. The process of claim 1, further comprising a step of adding said cognitive behavior data and historical cognitive behavior data to a treatment record associated with the patient to produce evidence based care.

7. The process of claim 1, wherein said at least one mobile device is selected from a group consisting of smart phones, pads, tablets, personal digital assistants, and mobile computers.

8. The process of claim 1, further comprising the steps of:
(a) receiving survey results from the patient responding to a survey regarding an in-office visit; and
(b) having the health care provider prescribe treatment based on said survey results.

9. The process of claim 1, further comprising matching the patient to at least one additional health care provider.

10. A computer-assisted process for receiving cognitive behavior data for use in a therapy, said computer-assisted process comprising the steps of:
(a) providing at least one mobile device to a patient, wherein said at least one mobile device is functionally connected to a central repository;
(b) capturing and storing, in said central repository, via an interface on said at least one mobile device, said cognitive behavior data of the patient, thereby enabling remote and impromptu receipt of said cognitive behavior data without delay;
(c) retrieving said cognitive behavior data of the patient from said central repository;
(d) reviewing said cognitive behavior data by a health care provider as part of said therapy to produce a review;
(e) receiving survey results from the patient responding to a survey regarding an in-office visit; and
(f) having the health care provider prescribe treatment based on said survey results and said review;
wherein said step of capturing and storing is configured to encourage participation of the patient in said therapy and to discourage negative behaviors said therapy is designed to control.

11. The process of claim 10, further comprising:
(a) retrieving historical cognitive behavior data; and
(b) graphing said cognitive behavior data and said historical cognitive behavior data such that cognitive behavior change is discernible over time based on said cognitive behavior data in contrast to said historical cognitive behavior data.

12. The process of claim 10, wherein said step of capturing and storing is performed at predetermined time intervals.

13. The process of claim 12, further comprising a step of alerting the patient preceding said step of capturing and storing.

14. The process of claim 10, wherein said step of capturing and storing is performed at an ad hoc basis according to the need of the patient.

15. The process of claim 10, further comprising a step of adding said cognitive behavior data and historical cognitive behavior data to a treatment record associated with the patient to produce evidence based care.

16. The process of claim 10, wherein said at least one mobile device is selected from a group consisting of smart phones, pads, tablets, personal digital assistants, and mobile computers.

17. The process of claim 10, further comprising matching the patient to at least one additional health care provider.

18. A computer system for receiving cognitive behavior data of a patient for use in a therapy, said computer system comprising:
(a) at least one central repository capable of storing cognitive behavior data and historical cognitive behavior data;
(b) at least one mobile device assigned to the patient;
(c) at least one web server, functionally coupled to said at least one central repository and said at least one mobile device, said at least one web server is configured to:
(i) capture, at a remote location, said cognitive behavior data and store said cognitive behavior data in said at least one central repository;
(ii) retrieve said cognitive behavior data of the patient from said at least one central repository; and
(iii) retrieve historical cognitive behavior data of the patient from said at least one central repository.

19. The computer system of claim 18, wherein said at least one mobile device is selected from a group consisting of smart phones, pads, tablets, personal digital assistants, and mobile computers.

20. The computer system of claim 18, further comprising at least one computer assigned to at least one health care provider matched to the patient.
